(19) United States
(12) Patent Application Publication
(10) Pub. No.: US 2025/0149779 A1
(43) Pub. Date: May 8, 2025

(54) ANTENNA DEVICE

(71) Applicant: YOKOWO CO., LTD., Tokyo (JP)

(72) Inventors: Shuta MATSUMURA, Tomioka-shi, Gunma (JP); Minoru ARATA, Tomioka-shi, Gunma (JP); Masashi NODA, Tomioka-shi, Gunma (JP)

(73) Assignee: YOKOWO CO., LTD., Tokyo (JP)

(21) Appl. No.: 18/832,110

(22) PCT Filed: Jan. 13, 2023
(86) PCT No.: PCT/JP2023/000748

§ 371 Date: Jul. 23, 2024

(30) Foreign Application Priority Data
Jan. 26, 2022 (JP) 2022-010479

(51) Int. Cl. H01Q 1/32; H01Q 1/22; H01Q 9/30

(52) U.S. Cl. CPC H01Q 1/3275; H01Q 1/22; H01Q 9/30

(57) ABSTRACT

An antenna device includes a base and an antenna element, at least a portion of the antenna element being attached to the base, in which a first attachment structure capable of attaching the at least a portion of the antenna element to the base is disposed at a position substantially symmetrical to a position to which the antenna element is attached with regard to the center of the base.

### TECHNICAL FIELD

The present invention relates to an antenna device.

### BACKGROUND ART

In recent years, various antenna devices have been developed. For example, as described in Patent Document 1, an antenna device includes a base, a case forming an accommodation room, and an antenna element accommodated in the accommodation room. The base has a metal base and a metal plate electrically connected to the metal base. In the antenna device, an appropriate metal plate is used in accordance with a type of vehicle and a type of antenna element to be mounted. Thus, a decrease in antenna gain due to unnecessary resonance is suppressed without changing the metal base in various antenna devices.

### RELATED DOCUMENT

### Patent Document

### Patent Document 1: WO2019/124518

### SUMMARY OF THE INVENTION

### Technical Problem

A drawing direction of an antenna cable of the antenna device may be limited due to restrictions for the vehicle on which the antenna device is mounted. As a result, different antenna bases are necessary depending on a difference in drawing directions of the antenna cables.

An example of an object of the present invention is to reduce the manufacturing cost of a plurality of types of antenna devices having different drawing directions of antenna cables. Other objects of the present invention will become apparent from the description herein.

### Solution to Problem

An aspect of the present invention is an antenna device including:
a base;
an antenna element, at least a portion of the antenna element being attached to the base,
in which a first attachment structure capable of attaching the at least a portion of the antenna element to the base is disposed at a position substantially symmetrical to a position to which the antenna element is attached with regard to a center of the base.

According to the above-mentioned aspect of the present invention, it is possible to reduce manufacturing costs of a plurality of types of antenna devices having different drawing directions of antenna cables.

### BRIEF DESCRIPTION OF THE DRAWINGS

FIG. 1 is a schematic top view of a vehicle according to an embodiment.

FIG. 2 is an exploded perspective view of a first antenna device according to the embodiment.

FIG. 3 is a top view of the first antenna device according to the embodiment with a first inner case, a first outer case, and a first outer pad removed.

FIG. 4 is a left side view of the first antenna device according to the embodiment with the first inner case, the first outer case, and the first outer pad removed.

FIG. 5 is a bottom view of the first antenna device according to the embodiment with the first inner case, the first outer case, and the first outer pad removed.

FIG. 6 is a top view of a second antenna device according to the embodiment with a second inner case, a second outer case, and a second outer pad removed.

FIG. 7 is a left side view of the second antenna device according to the embodiment with the second inner case, the second outer case, and the second outer pad removed.

FIG. 8 is a bottom view of the second antenna device according to the embodiment with the second inner case, the second outer case, and the second outer pad removed.

### DESCRIPTION OF EMBODIMENTS

In recent years, there is an increasing variety of antenna mounted on a vehicle. A plurality of antennas of the same type may be mounted to improve transmission and reception performance. As a result, it may be difficult to mount all the antenna elements in one antenna device. It is therefore under consideration that a plurality of types of antenna elements are divided to a plurality of types of antenna devices and the plurality of types of antenna elements are mounted on a vehicle.

When there is one antenna device mounted on a roof of the vehicle, the antenna device is commonly mounted at the center position in the front or rear of the vehicle. When two antenna devices are mounted on the roof of the vehicle, however, it is conceivable to mount the antenna devices on each of the rear right and the rear left of the vehicle. When the antenna device is mounted at such a position, wiring the antenna cable under the roof of the vehicle requires that an antenna cable extending from an antenna device mounted on the rear right of the vehicle be drawn to the left side of the vehicle and an antenna cable extending from an antenna device mounted on the rear left of the vehicle be drawn to the right side of the vehicle.

Thus, drawing directions of the antenna cables may be different due to restrictions on attachment positions of the antenna devices and a structure of an inside of the vehicle. Such a case requires different structure of the bases of the two antenna devices. The use of the bases having different structures for each of the two antenna devices, however, causes an increase in manufacturing costs of the antenna device.

Hereinafter, embodiments of the present invention will be described, with reference to the drawings. In all drawings, the same constituent components are denoted by the same reference signs, and detailed explanation thereof will not be repeated.

In the present specification, ordinal numbers, such as “first”, “second”, and “third”, are attached only for distinguishing components to which the same names are attached unless otherwise specified, and do not mean particular features (for example, an order or a degree of importance) of the components.

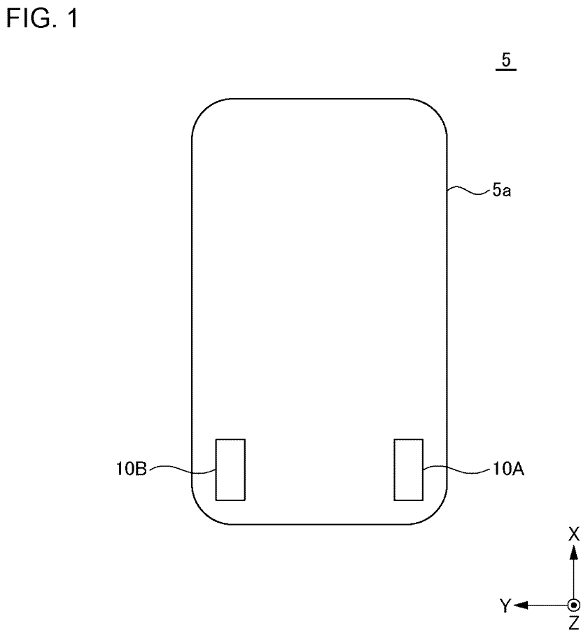

FIG. 1 is a schematic top view of a vehicle 5 according to the embodiment.

In FIG. 1, an arrow indicating a first direction X or a second direction Y indicates that a direction from a base end toward a tip end of the arrow is a positive direction of a direction indicated by the arrow and a direction from the tip end toward the base end of the arrow is a negative direction of the direction indicated by the arrow. A black-dot-marked white circle indicating a third direction Z indicates that a direction from the rear toward the front of the page plane is the positive direction of the third direction Z and a direction from the front toward the rear of the page plane is the negative direction of the third direction Z.

The first direction X is a direction which is parallel to the front-rear direction of the vehicle 5. Specifically, a positive direction in the first direction X is a direction from a rear side toward a front side of the vehicle 5. A negative direction in the first direction X is a direction from the front side toward the rear side of the vehicle 5. The second direction Y is orthogonal to the first direction X and is a direction parallel to the right-left direction of the vehicle 5. Specifically, a positive direction in the second direction Y is a direction from a right side toward a left side of the vehicle 5 as viewed from an upper side of the vehicle 5. The negative direction in the second direction Y is a direction from the left side toward the right side of the vehicle 5 as viewed from an upper side of the vehicle 5. The third direction Z is orthogonal to both the first direction X and the second direction Y and is a direction parallel to an up-down direction of the vehicle 5. Specifically, the positive direction of the third direction Z is a direction from a lower side toward the upper side of the vehicle 5. The negative direction of the third direction Z is a direction from the upper side toward the lower side of the vehicle 5.

The vehicle 5 is, for example, an automobile such as an autotruck or a passenger automobile. A first antenna device 10A and a second antenna device 10B are mounted on a roof 5a of the vehicle 5. The first antenna device 10A is mounted on the rear right of the roof 5a. The second antenna device 10B is mounted on the rear left of the roof 5a.

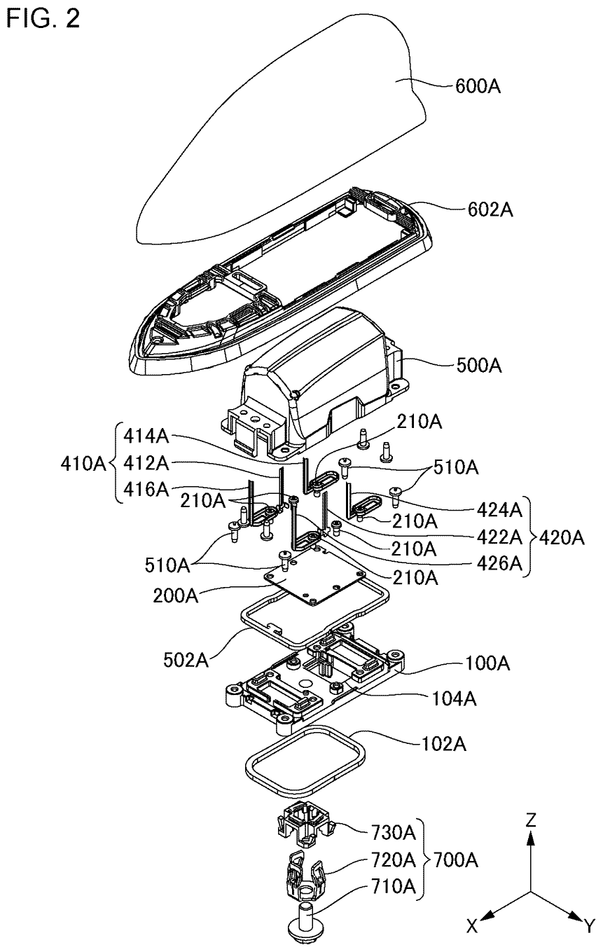

FIG. 2 is an exploded perspective view of the first antenna device 10A according to the embodiment. In FIG. 2, an arrow indicating the third direction Z indicates that the direction from the base end toward the tip end of the arrow is the positive direction of the third direction Z and the direction from the tip end to the base end of the arrow is the negative direction of the third direction Z.

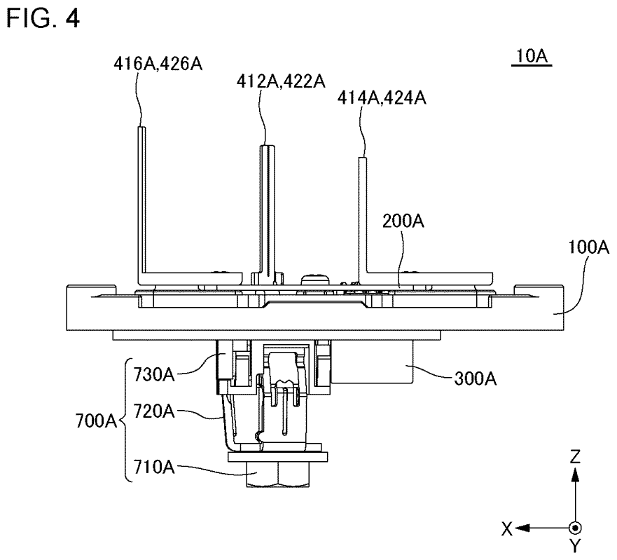

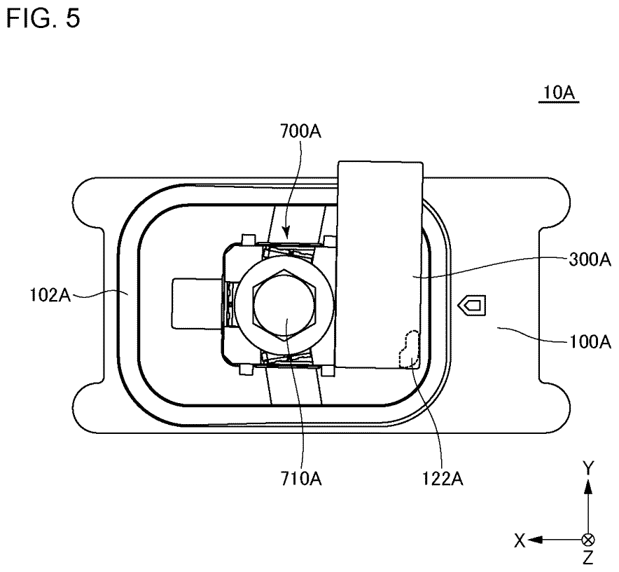

The first antenna device 10A includes a first base 100A, a first attachment seal member 102A, a first substrate 200A, a first antenna element 410A, a second antenna element 420A, a first inner case 500A, a first inner pad 502A, a first outer case 600A, a first outer pad 602A, and a first fastener 700A. The first antenna element 410A includes a first element 412A, a second element 414A, and a third element 416A. The second antenna element 420A has a fourth element 422A, a fifth element 424A, and a sixth element 426A. The first fastener 700A includes a first fastening screw 710A, a first washer 720A, and a first holder 730A. As shown in FIGS. 4 and 5 to be described later, the first antenna device 10A further includes a first connector 300A. For simplicity of description, FIG. 2 does not show the first connector 300A.

The first base 100A is made of metal, for example. The first base 100A is mounted on the upper surface side of the roof 5a with the first attachment seal member 102A therebetween. The first attachment seal member 102A is made of an elastic material such as elastomer and rubber. As viewed in the third direction Z, the first attachment seal member 102A forms a surrounding body surrounding the first connector 300A and the first fastener 700A. The provision of the first attachment seal member 102A can suppress moisture from entering a gap between a lower surface of the first base 100A and the upper surface of the roof 5a.

The first substrate 200A is located above the first base 100A. For example, the first substrate 200A is a printed circuit board (PCB). The first substrate 200A is attached to the first base 100A via six first substrate attaching screws 210A.

As shown in FIGS. 4 and 5 to be described later, the first connector 300A is located under the first substrate 200A. In an example, the first connector 300A is connected to a lower surface of the first substrate 200A via soldering. The first connector 300A is inserted into the first insertion hole 104A provided in the first base 100A with the first substrate 200A attached to the first base 100A. In the embodiment, the first connector 300A is located rearward of the first fastener 700A.

The first antenna element 410A is, for example, a Wi-Fi (registered trademark) antenna. The first antenna element 410A is disposed above the first base 100A with the first substrate 200A therebetween. As viewed from above, the first antenna element 410A is located on a right side of a center of the first base 100A in the second direction Y. The first antenna element 410A is an array antenna configured to include the first element 412A, the second element 414A, and the third element 416A. The first element 412A, the second element 414A, and the third element 416A are monopole elements substantially parallel to the third direction Z. The first element 412A, the second element 414A, and the third element 416A are arranged substantially parallel to the first direction X. The first element 412A is located between the second element 414A and the third element 416A in the first direction X. The second element 414A is located rearward of the first element 412A. The third element 416A is located forward of the first element 412A.

The second antenna element 420A is, for example, a Bluetooth (registered trademark) antenna. The second antenna element 420A is disposed above the first base 100A with the first substrate 200A therebetween. As viewed from above, the second antenna element 420A is located on a left side of the center of the first base 100A in the second direction Y. The second antenna element 420A is an array antenna configured to include the fourth element 422A, the fifth element 424A, and the sixth element 426A. The fourth element 422A, the fifth element 424A, and the sixth element 426A are monopole elements substantially parallel to the third direction Z. The fourth element 422A, the fifth element 424A, and the sixth element 426A are arranged substantially parallel to the first direction X. The fourth element 422A is located between the fifth element 424A and the sixth element 426A in the first direction X. The fifth element 424A is located on rearward of the fourth element 422A. The sixth element 426A is located forward of the fourth element 422A.

The first inner case 500A is mounted on an upper surface side of the first base 100A with the first inner pad 502A therebetween. The first inner pad 502A is made of an elastic material such as elastomer and rubber. As viewed in the third direction Z, the first inner pad 502A forms a surrounding body surrounding the first substrate 200A, the first antenna element 410A, and the second antenna element 420A. The provision of the first inner pad 502A can suppress moisture from entering a gap between a lower end of the first inner case 500A and the upper surface of the first base 100A.

The first inner case 500A covers the first substrate 200A, the first antenna element 410A, and the second antenna element 420A from above the first base 100A. Thus, the first inner case 500A, as well as the first base 100A, form an accommodation room accommodating the first substrate 200A, the first antenna element 410A, and the second antenna element 420A. The first inner case 500A is attached to the first base 100A via four first case attaching screws 510A.

The first outer case 600A is mounted on the upper surface side of the roof 5a with the first outer pad 602A therebetween. The first outer pad 602A is made of an elastic material such as elastomer and rubber. As viewed in the third direction Z, a portion of the first outer pad 602A from a center portion thereof in the first direction X to an end portion thereof on a side in the negative direction in the first direction X forms a surrounding body surrounding the first base 100A, the first substrate 200A, the first antenna element 410A, the second antenna element 420A, and the first inner case 500A.

The first fastener 700A fastens the first base 100A to the roof 5a and electrically grounds the first base 100A to the roof 5a. Specifically, the roof 5a is provided with an attachment hole for attaching the first antenna device 10A. The first holder 730A is disposed inside the attachment hole. The first washer 720A is held by the first holder 730A. The first fastening screw 710A extends through a through-hole provided in the first washer 720A in the third direction Z and is screwed into a screw hole provided on the lower surface of the first base 100A. The screwing the first fastening screw 710A into the screw hole of the first base 100A brings a tip of a claw provided in the first washer 720A into contact with the lower surface of the roof 5a. Thus, the first base 100A is fastened to the roof 5a. The first base 100A is electrically grounded to the roof 5a through the first fastening screw 710A and the first washer 720A.

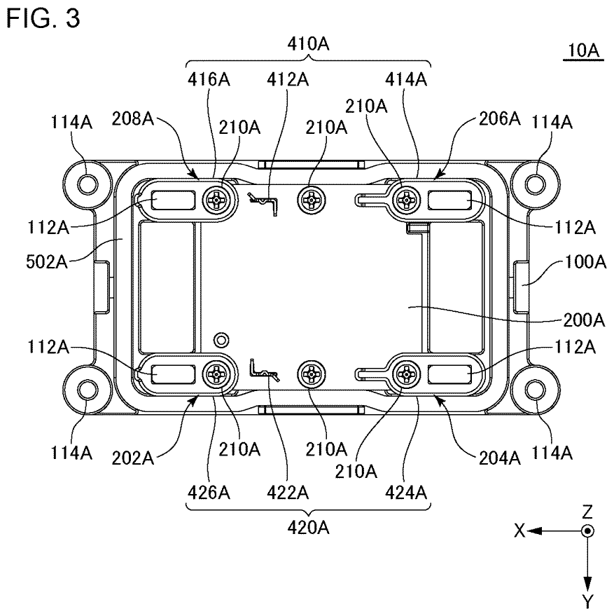

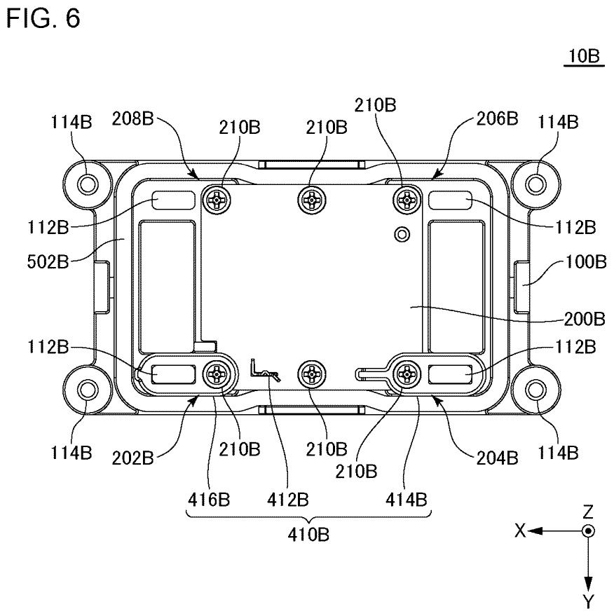

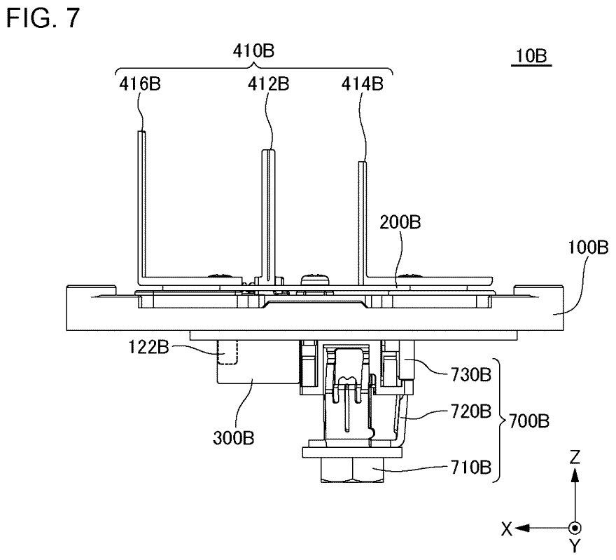

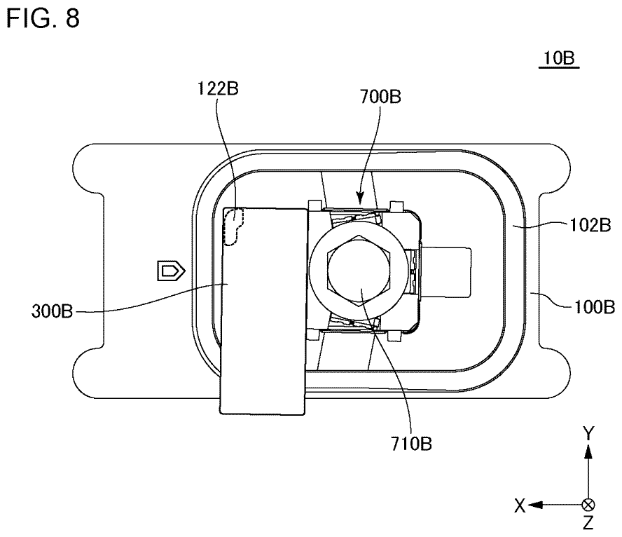

FIG. 3 is a top view of the first antenna device 10A according to the embodiment with the first inner case 500A, the first outer case 600A, and the first outer pad 602A removed. FIG. 4 is a left side view of the first antenna device 10A according to the embodiment with the first inner case 500A, the first outer case 600A, and the first outer pad 602A removed. FIG. 5 is a bottom view of the first antenna device 10A according to the embodiment with the first inner case 500A, the first outer case 600A, and the first outer pad 602A removed. FIG. 6 is a top view of the second antenna device 10B according to the embodiment with a second inner case, a second outer case, and a second outer pad removed. FIG. 7 is a left side view of the second antenna device 10B according to the embodiment with the second inner case, the second outer case, and the second outer pad removed. FIG. 8 is a bottom view of the second antenna device 10B according to the embodiment with the second inner case, the second outer case, and the second outer pad removed.

In FIGS. 4 and 7, a black-dot-marked white circle indicating the second direction Y indicates that a direction from the rear toward the front of the page plane is the positive direction in the second direction Y and a direction from the front toward the rear of the page plane is the negative direction in the second direction Y. In FIGS. 5 and 8, an X-marked white circle indicating the third direction Z indicates that a direction from the front toward the rear of the page plane is the positive direction of the third direction Z and a direction from the rear toward the front of the page plane is the negative direction of the third direction Z.

As shown in FIGS. 6 to 8, the second antenna device 10B according to the embodiment includes a second base 100B, a second attachment seal member 102B, a second substrate 200B, a second connector 300B, a third antenna element 410B, a second inner pad 502B, and a second fastener 700B. The second antenna device 10B according to the embodiment further includes a second inner case, a second outer case, and a second outer pad not shown in the drawing in a similar manner to the first inner case 500A, the first outer case 600A, and the first outer pad 602A of the first antenna device 10A according to the embodiment. As described above, in FIGS. 6 to 8, the second inner case, the second outer case, and the second outer pad are removed. The third antenna element 410B has a seventh element 412B, an eighth element 414B, and a ninth element 416B. The second fastener 700B has a second fastening screw 710B, a second washer 720B, and a second holder 730B.

The first connector 300A covers a first pin 122A to be described later from the lower side of the first base 100A. Accordingly, in FIG. 5, the first pin 122A is illustrated as being transmitted through the first connector 300A. Similarly, the second connector 300B covers a second pin 122B to be described later from the lower side of the second base 100B. Accordingly, in FIGS. 7 and 8, the second pin 122B is illustrated as being transmitted through the second connector 300B.

Referring to FIGS. 3 to 8 and optionally referring to FIGS. 1 and 2, the first antenna device 10A and the second antenna device 10B will be compared with each other.

In the embodiment, a structure such as dimensions and a shape of the first base 100A and a structure such as dimensions and a shape of the second base 100B are substantially the same. Accordingly, the manufacturing costs of the first antenna device 10A and the second antenna device 10B can be reduced as compared with a case where the structure of the first base 100A and the structure of the second base 100B are different. Even if the structure of the first base 100A and the structure of the second base 100B are substantially the same, difference between the orientation of the first base 100A in the first direction X and the orientation of the second base 100B in the first direction X permits difference between the drawing direction of a first antenna cable of the first antenna device 10A and the drawing direction of a second antenna cable of the second antenna device 10B as described below in the embodiment. In the embodiment, therefore, the manufacturing costs of the plurality of types of antenna devices having different drawing directions of the antenna cables can be reduced as compared with a case where the structure of the first base 100A and the structure of the second base 100B are different. In the embodiment, as described below, even if the orientation of the first base 100A in the first direction and the orientation of the second base 100B in the first direction X are different, a structure and a position of the antenna element provided in the first antenna device 10A and a structure and a position of the antenna element provided in the second antenna device 10B can be substantially the same.

First, the drawing direction of the first antenna cable from the first antenna device 10A and the drawing direction of the second antenna cable from the second antenna device 10B will be described.

One end of the first antenna cable not shown in the drawing is connected to a side surface of the first connector 300A on the positive direction side in the second direction Y. The other end of the first antenna cable is electrically connected to an electrical device, which is not shown in the drawing, provided in the vehicle 5. As described with reference to FIG. 1, the first antenna device 10A is mounted on the rear right of the vehicle 5. Accordingly, the first antenna cable cannot be drawn to the right side of the first base 100A as viewed from above and needs to be drawn to the left side of the first base 100A as viewed from above. In the embodiment, the first connector 300A has a configuration to draw the first antenna cable in a direction other than the third direction Z perpendicular to the first base 100A. Specifically, the first connector 300A has a configuration to draw the first antenna cable toward the positive direction side of the first antenna device 10A in the second direction Y.

As shown in FIG. 5, the first pin 122A is provided on the lower surface of the first base 100A. As viewed in the third direction Z, the first pin 122A is located on rearward of the first fastener 700A and on the negative direction side of the first connector 300A in the second direction Y. The first pin 122A is provided to prevent the first base 100A from rotating together with the rotation of the first fastening screw 710A when the first fastening screw 710A is screwed into a screw hole provided on the lower surface of the first base 100A. The first antenna cable needs to be drawn toward a side opposite to a side on which the first pin 122A is located with regard to the first connector 300A to prevent interference between the first antenna cable and the first pin 122A. For this reason, the first antenna cable can be drawn toward the opposite side to the side on which the first pin 122A is located with regard to the first connector 300A as described above.

One end of the second antenna cable not shown in the drawing is connected to a side surface of the second connector 300B on the negative direction side in the second direction Y. The other end of the second antenna cable is electrically connected to an electrical device, which is not shown in the drawing, provided in the vehicle 5. As described with reference to FIG. 1, the second antenna device 10B is mounted on the rear left of the vehicle 5. Accordingly, the second antenna cable cannot be drawn to the left side of the second base 100B as viewed from above and needs to be drawn to the right side of the second base 100B as viewed from above. In the embodiment, the second connector 300B has a configuration to draw the second antenna cable in a direction other than the third direction Z perpendicular to the second base 100B. Specifically, the second connector 300B has a configuration to draw the second antenna cable toward the negative direction side of the second antenna device 10B in the second direction Y.

As shown in FIGS. 7 and 8, the second pin 122B is provided on the lower surface of the second base 100B. As viewed in the third direction Z, the second pin 122B is located forward of the second fastener 700B and on the positive direction side of the second connector 300B in the second direction Y. The second pin 122B is provided to prevent the second base 100B from rotating together with the rotation of the second fastening screw 710B when the second fastening screw 710B is screwed into a screw hole provided on the lower surface of the second base 100B. The second antenna cable needs to be drawn toward a side opposite to a side on which the second pin 122B is located with regard to the second connector 300B to prevent interference between the second antenna cable and the second pin 122B. For this reason, the second antenna cable can be drawn toward the opposite side to the side on which the second pin 122B is located with regard to the second connector 300B as described above.

In the embodiment, an orientation of the first base 100A in the first direction X and an orientation of the second base 100B in the first direction X are opposite to each other in the first direction X. Accordingly, the first antenna cable can be drawn toward the left side of the first antenna device 10A and the second antenna cable can be drawn toward the right side of the second antenna device 10B. Thus, in the embodiment, the different orientations of the bases of the respective antenna devices permits the different drawing directions of the antenna cables of the respective antenna devices.

Next, the first antenna element 410A will be described.

As shown in FIG. 3, the first substrate 200A has a substantially square shape as viewed from a third direction Z. A shape of the first substrate 200A, however, is not limited to the example. Four first ribs 112A are provided on the upper surface of the first base 100A.

Hereinafter, as necessary, a left front corner of the first substrate 200A as viewed from above is referred to as a first corner 202A. Hereinafter, as necessary, a left rear corner of the first substrate 200A as viewed from above is referred to as a second corner 204A. Hereinafter, as necessary, a right rear corner of the first substrate 200A as viewed from above is referred to as a third corner 206A. Hereinafter, as necessary, a right front corner of the first substrate 200A as viewed from above is referred to as a fourth corner 208A.

A lower end of the first element 412A is attached to the first substrate 200A via soldering, for example. As shown in FIG. 3, as viewed from a third direction Z, the first element 412A is disposed closer to the fourth corner 208A than to the third corner 206A in the first direction X. A position at which the first element 412A is disposed, however, is not limited to the example.

As shown in FIG. 3, a portion of the lower end of the second element 414A overlapping the third corner 206A in the third direction Z, as well as the third corner 206A, are attached to the first base 100A via the first substrate attaching screw 210A provided at the third corner 206A. A rear portion of the lower end of the second element 414A of the third corner 206A is provided with a through-hole into which the first rib 112A located on rearward of the third corner 206A is inserted in the third direction Z. The second element 414A is aligned by inserting the first rib 112A into the through-hole of the second element 414A.

As shown in FIG. 3, a portion of the lower end of the third element 416A overlapping the fourth corner 208A in the third direction Z, as well as the fourth corner 208A, are attached to the first base 100A via the first substrate attaching screw 210A provided at the fourth corner 208A. A front portion of the lower end of the third element 416A of the fourth corner 208A is provided with a through-hole into which the first rib 112A located forward of the fourth corner 208A is inserted in the third direction Z. The third element 416A is aligned by inserting the first rib 112A into the through-hole of the third element 416A.

Next, the second antenna element 420A will be described.

A lower end of the fourth element 422A is attached to the first substrate 200A via soldering, for example. As shown in FIG. 3, as viewed in the third direction Z, the fourth element 422A is disposed closer to the first corner 202A than to the second corner 204A in the first direction X. A position at which the fourth element 422A is disposed, however, is not limited to the example.

As shown in FIG. 3, a portion of the lower end of the fifth element 424A overlapping the second corner 204A in the third direction Z, as well as the second corner 204A, are attached to the first base 100A via the first substrate attaching screw 210A provided at the second corner 204A. A rear portion of the lower end of the fifth element 424A of the second corner 204A is provided with a through-hole into which the first rib 112A located rearward of the second corner 204A is inserted in the third direction Z. The fifth element 424A is aligned by inserting the first rib 112A into the through-hole of the fifth element 424A.

As shown in FIG. 3, a portion of the lower end of the sixth element 426A overlapping the first corner 202A in the third direction Z, as well as the first corner 202A, are attached to the first base 100A via the first substrate attaching screw 210A provided at the first corner 202A. A front portion of the lower end of the sixth element 426A of the first corner 202A is provided with a through-hole into which the first rib 112A located forward of the first corner 202A is inserted in the third direction Z. The sixth element 426A is aligned by inserting the first rib 112A into the through-hole of the sixth element 426A.

Next, the third antenna element 410B will be described.

For example, the third antenna element 410B is a Wi-Fi (registered trademark) antenna. As viewed from above, the third antenna element 410B is located on a left side of the center of the second base 100B in the second direction Y. The third antenna element 410B is an array antenna configured to include the seventh element 412B, the eighth element 414B, and the ninth element 416B. The seventh element 412B, the eighth element 414B, and the ninth element 416B are monopole elements substantially parallel to the third direction Z. As shown in FIG. 6, as viewed from a third direction Z, the second substrate 200B has substantially the same shape as the first substrate 200A. In the same manner as the first substrate 200A, the second substrate 200B is attached to the second base 100B via six second substrate attaching screws 210B. In the same manner as the first base 100A, four second ribs 112B are provided on an upper surface of the second base 100B.

Hereinafter, as necessary, a left front corner of the second substrate 200B as viewed from above is referred to as a fifth corner 202B. Hereinafter, as necessary, a left rear corner of the second substrate 200B as viewed from above is referred to as a sixth corner 204B. Hereinafter, as necessary, a right rear corner of the second substrate 200B as viewed from above is referred to as a seventh corner 206B. Hereinafter, as necessary, a right front corner of the second substrate 200B as viewed from above is referred to as an eighth corner 208B.

A lower end of the seventh element 412B is attached to the second substrate 200B via soldering, for example. As shown in FIG. 6, as viewed in the third direction Z, the seventh element 412B is disposed closer to the fifth corner 202B than to the sixth corner 204B in the first direction X. A position at which the seventh element 412B is disposed, however, is not limited to the example.

As shown in FIG. 6, a portion of the lower end of the eighth element 414B overlapping the sixth corner 204B in the third direction Z, as well as the sixth corner 204B, are attached to the 2 base 100B via the second substrate attaching screw 210B provided at the sixth corner 204B. A rear portion of the lower end of the eighth element 414B of the sixth corner 204B is provided with a through-hole into which the second rib 112B located rearward of the sixth corner 204B is inserted in the third direction Z. The eighth element 414B is aligned by inserting the second rib 112B into the through-hole of the eighth element 414B.

As shown in FIG. 6, a portion of the lower end of the ninth element 416B overlapping the fifth corner 202B in the third direction Z, as well as the fifth corner 202B, are attached to the 2 base 100B via the second substrate attaching screw 210B provided at the fifth corner 202B. A front portion of the lower end of the ninth element 416B of the fifth corner 202B is provided with a through-hole into which the second rib 112B located forward of the fifth corner 202B is inserted in the third direction Z. The ninth element 416B is aligned by inserting the second rib 112B into the through-hole of the ninth element 416B.

As shown in FIG. 6, no element constituting the antenna element is disposed at the seventh corner 206B and the eighth corner 208B.

In the embodiment, in the first antenna device 10A, as viewed from a third direction Z, the attachment structure capable of attaching at least a portion of the first antenna element 410A and at least a portion of the second antenna element 420A to the first base 100A is disposed at a position substantially symmetrical to a position to which the first antenna element 410A and the second antenna element 420A are attached with regard to the center of the first base 100A. Specifically, in the embodiment, as shown in FIG. 3, as viewed from a third direction Z, four first substrate attaching screws 210A provided at the four corners of the first substrate 200A and the four first ribs 112A provided in the vicinity of the four first substrate attaching screws 210A are disposed substantially symmetrically with regard to the center of the first base 100A. For this reason, as shown in FIGS. 3 and 6, the relative positions of the antenna elements with regard to the center of the base as viewed from a third direction Z in each of the first antenna device 10A and the second antenna device 10B can be substantially the same even if the orientation of the first base 100A in the first direction X and the orientation of the second base 100B in the first direction X are opposite to each other in the first direction X. Specifically, in the embodiment, as viewed from a third direction Z, a relative position of the second antenna element 420A with regard to the center of the first base 100A and a relative position of the third antenna element 410B with regard to the center of the second base 100B are substantially the same.

In the embodiment, as shown in FIG. 5, at least a portion of the first fastener 700A overlaps with the center of the first base 100A in the third direction Z. As shown in FIG. 7, at least a portion of the second fastener 700B overlaps with the center of the second base 100B in the third direction Z. For this reason, a relative position of the first antenna element 410A or the second antenna element 420A with regard to the attachment hole of the roof 5a for the first base 100A and a relative position of the third antenna element 410B with regard to the attachment hole of the roof 5a for the second base 100B can be substantially the same as viewed from a third direction Z even if the orientation of the first base 100A in the first direction X and the orientation of the second base 100B in the first direction X are opposite to each other in the first direction X.

In the embodiment, as shown in FIG. 3, the first base 100A is substantially two-fold symmetric as viewed from a third direction Z. Accordingly, a shape of the portion of the first outer pad 602A surrounding the first base 100A and a shape of the portion of the second outer pad, which are not shown in the drawing, surrounding the second base 100B can be substantially the same. Accordingly, manufacturing costs of the first antenna device 10A and the second antenna device 10B can be reduced as compared with a case where the first base 100A is asymmetric as viewed from a third direction Z.

In the embodiment, as shown in FIG. 3, four first screw holes 114A are provided on the upper surface of the first base 100A. Specifically, as viewed in the third direction Z, the first base 100A has a pair of long sides substantially parallel to the first direction X and a pair of short sides substantially parallel to the second direction Y. As viewed in the third direction Z, a substantially semi-circular protrusion is provided on each of a left end portion and a right end portion of each of the pair of short sides of the first base 100A. The four first screw holes 114A are provided on the upper surface of the four protrusions. Each of the four first case attaching screws 510A shown in FIG. 2 is screwed into each of the four first screw holes 114A. Thus, the first screw hole 114A and the first case attaching screw 510A function as an attachment structure to attach at least a portion of the first inner case 500A to the first base 100A. The example of the attachment structure to attach at least a portion of the first inner case 500A to the first base 100A, however, is not limited to the first screw hole 114A and the first case attaching screw 510A. As shown in FIG. 6, the second base 100B is also provided with four second screw holes 114B in the same manner as the first base 100A.

As shown in FIG. 3, the four first screw holes 114A are disposed substantially symmetrically with regard to the center of the first base 100A. Thus, as viewed from a third direction Z, the relative positions of the four first screw holes 114A with regard to the center of the first base 100A and the relative positions of the four second screw holes 114B with regard to the center of the second base 100B can be substantially the same. For this reason, the structure of the first inner case 500A and the structure of the second inner case not shown in the drawing can be substantially the same. Accordingly, the manufacturing costs of the first antenna device 10A and the second antenna device 10B can be reduced as compared with a case where the structure of the first inner case 500A and the structure of the second inner case not shown in the drawing are different.

Although the example embodiments of the present invention have been described above with reference to the drawings, these are examples of the present invention, and various configurations other than the above may be adopted.

For example, in the embodiment, as viewed from a third direction Z, the relative position of at least a portion of the antenna element with regard to the center of the base can be substantially the same both before the base is rotated by 180° and after the base is rotated by 180°. As viewed from a third direction Z, a relative position of at least a portion of the antenna element with regard to the center of the base, however, may be substantially the same both before the base is rotated by (360/n)° and after the base is rotated by (360/n)° (n is a natural number equal to or greater than 2) by disposing at least a portion of the antenna element and an attachment structure capable of attaching at least a portion of the antenna element to the base at positions substantially symmetrical with regard to the center of the base as viewed from a third direction Z.

In the embodiment, the antenna element mounted on each base is an array antenna. The antenna element mounted on each base, however, is not limited to the array antenna.

In the embodiment, the drawing direction of the first antenna cable from the first antenna device 10A and the drawing direction of the second antenna cable from the second antenna device 10B are reversed in the right-left direction. In the embodiment, however, the drawing direction of the first antenna cable from the first antenna device 10A and the drawing direction of the second antenna cable from the second antenna device 10B may be reversed in the front-rear direction.

According to the present specification, the following aspects are provided.

### Aspect 1

Aspect 1 is an antenna device including:
a base;
an antenna element, at least a portion of the antenna element being attached to the base,
in which a first attachment structure capable of attaching the at least a portion of the antenna element to the base is disposed at a position substantially symmetrical to a position to which the antenna element is attached with regard to a center of the base.

According to Aspect 1, the relative positions of the antenna elements with regard to the center of the base of each of the plurality of types of antenna devices can be substantially the same even if the orientations of the respective bases of the plurality of types of antenna devices are different from each other. For this reason, different orientations of the respective bases of the plurality of types of antenna devices permits different drawing directions of the antenna cables of the plurality of types of antenna devices when the structures of the respective bases of the plurality of types of antenna devices are substantially the same. Accordingly, the manufacturing costs of the plurality of types of antenna devices having different drawing directions of the antenna cables can be reduced as compared with a case where the structures of the respective bases of the plurality of types of antenna devices are different from each other.

### Aspect 2

Aspect 2 is the antenna device according to Aspect 1, further including:
a case forming an accommodation room accommodating the antenna element,
in which a second attachment structure to attach at least a portion of the case to the base is disposed substantially symmetrically.

According to Aspect 2, the structures of the cases attached to the respective bases can be substantially the same even if the orientations of the respective bases of the plurality of types of antenna devices are different from each other. Accordingly, the manufacturing costs of the plurality of types of antenna devices having different drawing directions of the antenna cables can be reduced as compared with a case where the structures of the cases attached to the respective bases are different from each other.

### Aspect 3

Aspect 3 is the antenna device according to Aspect 1 or 2, further including:
a fastener to fasten the base to a vehicle,
in which at least a portion of the fastener overlaps with the center of the base.

According to Aspect 3, the relative positions of the antenna elements with regard to the attachment holes of the roof of the vehicle for the respective bases can be substantially the same even if the orientations of the respective bases of the plurality of types of antenna devices are different from each other.

### Aspect 4

Aspect 4 is the antenna device according to any one of Aspects 1 to 3,
in which the base is substantially rotationally symmetric as viewed from a predetermined direction.

According to Aspect 4, the shapes of the pads surrounding the respective bases can be substantially the same even if the orientations of the bases of the plurality of types of antenna devices are different from each other. Accordingly, the manufacturing costs of the plurality of types of antenna devices having different drawing directions of the antenna cables can be reduced as compared with a case where the shapes of the pads surrounding the respective bases are different from each other.

### Aspect 5

Aspect 5 is the antenna device according to any one of Aspects 1 to 4,
in which the base has a configuration to draw an antenna cable in a predetermined direction other than a direction perpendicular to the base.

According to Aspect 5, the antenna cable extending from the base can be changed in accordance with the orientation of the base. For example, when the base is mounted on the left of the vehicle, the antenna cable extending from the base can be drawn to the right side of the vehicle in accordance with the orientation of the base. When the base is mounted on the right of the vehicle, the antenna cable extending from the base can be drawn to the left side of the vehicle in accordance with the orientation of the base.

This application claims priority based on Japanese Patent Application No. 2022-010479 filed on Jan. 26, 2022, the entire content of which is incorporated herein by reference.

### REFERENCE SIGNS LIST

5 vehicle, 5a roof, 10A first antenna device, 10B second antenna device, 100A first base, 100B second base, 102A first attachment seal member, 102B second attachment seal member, 104A first insertion hole, 112A first rib, 112B second rib, 114A first screw hole, 114B second screw hole, 122A first pin, 122B second pin, 200A first substrate, 200B second substrate, 202A first corner, 202B fifth corner, 204A second corner, 204B sixth corner, 206A third corner, 206B seventh corner, 208A fourth corner, 208B eighth corner, 210A first substrate attaching screw, 210B second substrate attaching screw, 300A first connector, 300B second connector, 410A first antenna element, 410B third antenna element, 412A first element, 412B seventh element, 414A second element, 414B eighth element, 416A third element, 416B ninth element, 420A second antenna element, 422A fourth element, 424A fifth element, 426A sixth element, 500A first inner case, 502A first inner pad, 502B second inner pad, 510A first case attaching screw, 600A first outer case, 602A first outer pad, 700A first fastener, 700B second fastener, 710A first fastening screw, 710B second fastening screw, 720A first washer, 720B second washer, 730A first holder, 730B second holder, X first direction, Y second direction, Z third direction

1. An antenna device comprising:
a base; and
an antenna element, at least a portion of the antenna element being attached to the base,
wherein a first attachment structure capable of attaching the at least a portion of the antenna element to the base is disposed at a position substantially symmetrical to a position to which the antenna element is attached with regard to a center of the base.

2. The antenna device according to claim 1, further comprising:
a case forming an accommodation room accommodating the antenna element,
wherein a second attachment structure attaching at least a portion of the case to the base is disposed substantially symmetrically.

3. The antenna device according to claim 1, further comprising:
a fastener to fasten the base to a vehicle,
wherein at least a portion of the fastener overlaps with the center of the base.

4. The antenna device according to claim 1,
wherein the base is substantially rotationally symmetric as viewed from a predetermined direction.

5. The antenna device according to claim 1,
wherein the base includes a configuration to draw an antenna cable in a predetermined direction other than a direction perpendicular to the base.
